(19) United States
(12) Patent Application Publication
(10) Pub. No.: US 2017/0201008 A1
(43) Pub. Date: Jul. 13, 2017

(54) MOBILE TERMINAL

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Hao WU, Beijing (CN)

(21) Appl. No.: 15/242,023

(22) Filed: Aug. 19, 2016

Related U.S. Application Data
(63) Continuation of application No. PCT/CN2016/088694, filed on Jul. 5, 2016.

(30) Foreign Application Priority Data
Jan. 8, 2016 (CN) 2016100119452

(51) Int. Cl. H01Q 1/24; H01Q 1/22; H01Q 1/36; H04B 5/00; H01Q 21/00

(52) U.S. Cl. CPC H01Q 1/243; H04B 5/0031; H01Q 21/00; H01Q 1/36; H01Q 1/2291

(57) ABSTRACT

A mobile terminal comprises a radio frequency module, comprising at least two antenna connection ports, respectively a first antenna connection port and a second antenna connection port; a first antenna, connected to the first antenna connection port in the radio frequency module, wherein the first antenna is a near field communication (NFC) antenna; a second antenna, surrounding the first antenna, connected to the second antenna connection port in the radio frequency module, wherein the second antenna is used as a WiFi antenna in the Multi-input Multi-output (MIMO) antenna scheme.

### CROSS REFERENCE TO RELATED APPLICATIONS

The present application is a continuation of PCT application which has an application number of PCT/CN2016/088694 and was filed on Jul. 5, 2016.This application claims priority to Chinese Patent Application No. 201610011945.2, entitled “MOBILE TERMINAL” submitted to the State Intellectual Property Office on Jan. 8, 2016, the whole content of which is integrated into the present application by citation.

### TECHNICAL FIELD

The present invention relates to the technical field of sending and receiving signals, specifically, involving a mobile terminal.

### BACKGROUND

WiFi Standard introduces the Multi-input Multi-output (MIMO) technology from 802.11n. MIMO is an abstract mathematic model describing a multiple antennas wireless communication system that can send signals independently by the multiple antennas on the sending terminal, while receiving and restoring the information by multiple antennas on the receiving terminal. MIMO can increase the data throughput and transmitting distance of the system by large margin without increasing the bandwidth or total transmitted power loss, which draws a great attention to the technology in recent years. However, in MIMO antenna scheme, several sending antennas and receiving antennas need to be configured on the mobile phone, which require a large structural space. Limited by reasons such as narrow structural space, mobile terminals such as mobile phone has always failed to support MIMO.

In recent years, pushed by the requirement of on-line visit to the multimedia content by users, there is a dire need to apply MIMO to mobile terminals such as mobile phone. In the current technologies, there are multiple types of antennas in a mobile phone to perform different functions, such as GPS antenna for wireless call, WiFi antenna for wireless Internet access, and bluetooth antenna for short distance transmission, wherein GPS antenna comprises a master set antenna and at least one auxiliary set antenna. When the master set antenna is in operation, the auxiliary set antennas stand by and can be used as a WiFi antenna for the use of MIMO technology. The auxiliary set antennas of mobile phone are usually switched by a software controlled switch, such that each auxiliary set antenna can be used as WiFi antenna based on time-sharing for MIMO antenna scheme. The implementation manner use the existing antennas in the mobile phone and does not need to modify the structure of the mobile phone, whereas a switch needs to be added and a software is used to control the switch for switching, which makes it complicated. Under some complicated conditions, the normal conversation with mobile phone would be affected.

### SUMMARY

The present application aims to provide a mobile terminal that promotes its wireless performance in a weak signal environment.

According to one aspect of the present application, it provides a mobile terminal, comprising a radio frequency module comprising at least two antenna connection ports which are respectively a first antenna connection port and a second antenna connection port; a first antenna, connected to the first antenna connection port in the radio frequency module, wherein the first antenna is a near field communication (NFC) antenna; a second antenna surrounding the first antenna, connected to the second antenna connection port in the radio frequency module, wherein the second antenna is used as one WiFi antenna in the Multi-input Multi-output (MIMO) antenna scheme.

The technical solution provided in the present application is provided with a WiFi antenna around the NFC antenna, and the WiFi antenna coordinates with the radio frequency module, sending and receiving radio-frequency signals. When a mobile terminal, such as a mobile phone, is within a weak signal environment, the WiFi antenna can be used in coordination with the antennas within the mobile terminal, such as a mobile phone, and forms an MIMO scheme. The wireless performance of the mobile terminal at this time is good, so is the user experience.

### BRIEF DESCRIPTION OF THE DRAWINGS

One or more embodiments is/are accompanied by the following figures for illustrative purposes and serve to only to provide examples. These illustrative descriptions in no way limit any embodiments. Similar elements in the figures are denoted by identical reference numbers. Unless it states the otherwise, it should be understood that the drawings are not necessarily proportional or to scale.

FIG. 1 is a structure diagram of a mobile terminal provided in an embodiment of the present application;

FIG. 2 is a schematic diagram for a circuit logic of a mobile terminal provided in an embodiment of the present application

### PREFERABLE EMBODIMENT OF THE INVENTION

The example embodiments of the present publication are to be further elaborated in detail as follows with reference to the accompanying drawings. The drawings show the example embodiments of the present publication, whereas it should be appreciated that implementations of the present publication in various manners should not be limited by the embodiments elaborated herein. Reversely, the embodiments are provided for better understanding of the present publication, and completely conveying the whole scope of the present publication to those skilled in the art.

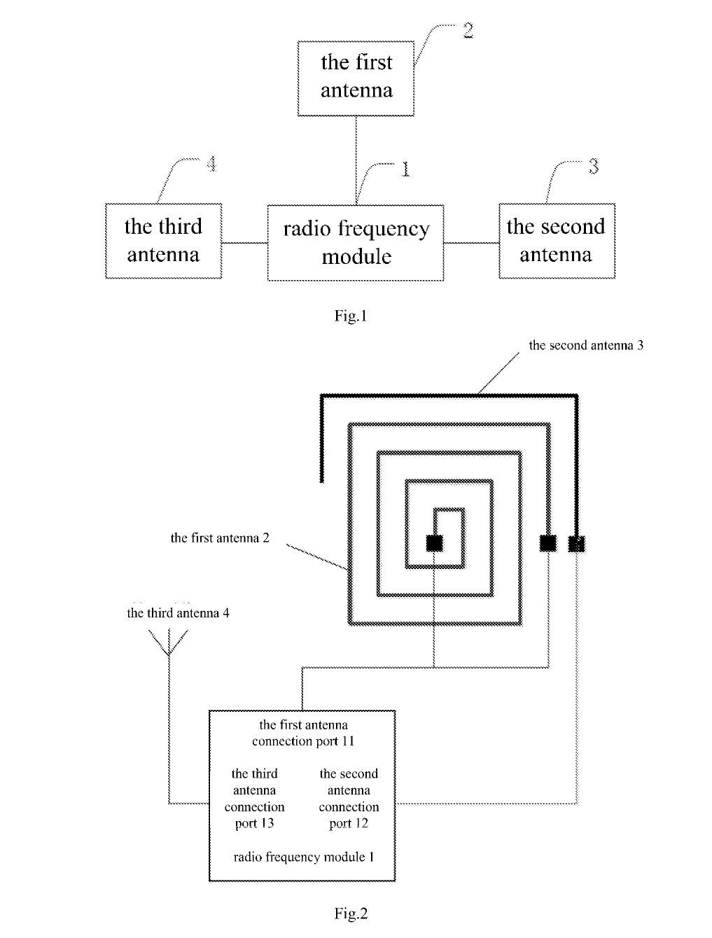

FIG. 1 is a structure diagram of a mobile terminal provided in an embodiment of the present application. As shown in FIG. 1, the mobile terminal comprises a radio frequency module 1, a first antenna 2, a second antenna 3 and a third antenna 4.

The radio frequency module comprises several antenna connection ports.

In the present embodiment, the radio frequency module 1 comprises a first antenna connection port 11, a second antenna connection port 12 and a third antenna connection port 13, which are shown in FIG. 2.

The first antenna 2 is connected to the first antenna connection port 11 in the radio frequency module 1.

In the present embodiment, the first antenna is a near field communication (NFC) antenna that can conduct short distance wireless communications among mobile devices, consumer electronic products, PC and intelligent widget tools. The NFC antenna is made of circuit coil made by the wire wrapping/printing/etching techniques and the anti-interference ferric oxide body material.

Wherein the first antenna 2 comprises a first dielectric substrate and a first radiation unit. Two feeder line sites are both connected to the first antenna connection port 11. The first radiation unit is a square torus.

The working frequency of the NFC antenna is usually hundreds of MHz, and the working frequency of WiFi antenna is between 2.4 GHz and 5 GHz. Thus, it does not affect the normal operation of the NFC antenna by setting the WiFi antenna around the NFC antenna. Other antennas within the mobile phone, such as GPS antenna, do not have sufficient surrounding spaces, and their working frequencies resemble that of NFC antenna. Accordingly, if they are close to each other, they would influence each other to lower their working efficiencies.

The second antenna 3 is set surrounding the first antenna 2, connects to the second antenna connection port 12 in the radio frequency module 1, wherein the second antenna 3 is used as a WiFi antenna in the Multi-input Multi-output (MIMO) antenna scheme, as shown in FIG. 2.

In the present embodiment, the second antenna 3 may partially surround the first antenna 2. The second antenna 3 may comprise a second dielectric substrate and a second radiation unit, wherein the second radiation unit extends in a linear shape, and partially surrounds the first radiation unit. The linear shape is an L shape or a square shape opened on a side, such that feeder lines of the first antenna 2 are led out from an opening.

Wherein the first dielectric substrate and the second dielectric substrate are the same dielectric substrate.

The working frequency of the NFC antenna is usually hundreds of MHz, and the working frequency of WiFi antenna is between 2.4 GHz and 5 GHz. Thus, it does not affect the normal operation of the NFC antenna by configuring the WiFi antenna around the NFC antenna. Other antennas within the mobile phone, such as GPS antenna, do not have sufficient surrounding spaces, and their working frequencies resemble that of NFC antenna. Accordingly, if they are close to each other, they would influence each other to lower their working efficiencies.

In the present embodiment, the mobile terminal further comprises a third antenna 4 which connects to the third antenna connection port 13 in the radio frequency module 1, wherein the third antenna 4 is used as another WiFi antenna in the MIMO antenna scheme.

In the present embodiment, the second antenna 3 maintains in electric communication with the second antenna connection port 12 in the radio frequency module 1. The second antenna 3 coordinates with the radio frequency module 1, sending and receiving radio-frequency signals.

The second antenna 3 and the third antenna 4 respectively connect to the radio frequency module 1, and may form the WiFi antennas in the MIMO antenna scheme.

Technical solution provided in the embodiment of the present application sets a WiFi antenna around the NFC antenna, and the WiFi antenna coordinates with the radio frequency module, sending and receiving radio-frequency signals. When a mobile terminal, such as a mobile phone, is within a weak signal environment, the WiFi antenna can be used in coordination with the antennas within the mobile terminal, such as a mobile phone, and forms an MIMO scheme. The wireless performance of the mobile terminal at this time is good, so is the user experience.

In specific implementations, the mobile terminal provided in the embodiments of the present application can be mobile phone, laptop PC, tablet PC or the like, and can be set customized to the users' practical requirements.

It should be explained that the mobile terminal involved in the present embodiment may adopt the mobile terminal structure described in the above embodiment. Please refer to corresponding content in the above embodiment for its specific implementation and operation mechanism, which would not be repeated herein.

According to the embodiments of the present application as stated above, these embodiments have not elaborated all the details, and do not limit the invention merely as the specific disclosed embodiments. Obviously, according to the above depiction, various amendments and changes can be made. The instant description selects and describes in detail these embodiments in order to better explain the mechanism and practical application of the present application, so as to facilitate the use of the present application and the amendments made on the present application by those skilled in the art. The present application is merely limited by the Claims, the whole scope thereof and the equivalents of the above.

1-7. (canceled)

8. A mobile terminal, comprising
a radio frequency module, comprising at least two antenna connection ports which are respectively a first antenna connection port and a second antenna connection port;
a first antenna, connected to the first antenna connection port in the radio frequency module, wherein the first antenna is a near field communication (NFC) antenna;
a second antenna surrounding the first antenna, connected to the second antenna connection port in the radio frequency module, wherein the second antenna is used as one WiFi antenna in the Multi-input Multi-output (MIMO) antenna scheme.

9. A mobile terminal according to claim 8, wherein the radio frequency module further comprises a third antenna connection port;
the mobile terminal further comprising a third antenna, connected to the third antenna connection port in the radio frequency module, wherein the third antenna is used as another WiFi antenna in the Multi-input Multi-output (MIMO) antenna scheme.

10. The mobile terminal according to any of claims 8, wherein the first antenna comprises a first dielectric substrate and a first radiation unit, and the second antenna comprises a second dielectric substrate and a second radiation unit, wherein the first dielectric substrate and the second dielectric substrate are the same dielectric substrate.

11. The mobile terminal according to any of claims 9, wherein the first antenna comprises a first dielectric substrate and a first radiation unit, and the second antenna comprises a second dielectric substrate and a second radiation unit, wherein the first dielectric substrate and the second dielectric substrate are the same dielectric substrate.

12. The mobile terminal according to claim 10, wherein the first radiation unit is a torus.

13. The mobile terminal according to claim 11, wherein the first radiation unit is a torus.

14. The mobile terminal according to claim 12, wherein the torus has a square shape.

15. The mobile terminal according to claim 13, wherein the torus has a square shape.

16. The mobile terminal according to claim 13, wherein the second radiation unit extends in a linear shape, and partially surrounds the first radiation unit.

17. The mobile terminal according to claim 10, wherein the second radiation unit extends in a linear shape, and partially surrounds the first radiation unit.

18. The mobile terminal according to claim 16, wherein the linear shape is an L shape or a square shape opened on a side, such that feeder lines of the first antenna are led out from an opening.

19. The mobile terminal according to claim 17, wherein the linear shape is an L shape or a square shape opened on a side, such that feeder lines of the first antenna are led out from an opening.
